(19) United States
(12) Patent Application Publication
(10) Pub. No.: US 2023/0022134 A1
(43) Pub. Date: Jan. 26, 2023

(54) FRAMEWORK FOR VALIDATING AND TROUBLESHOOTING NETWORK POLICY CONFIGURATIONS

(71) Applicant: VMWARE, INC., Palo Alto, CA (US)

(72) Inventors: Shriya Talwar, Pune (IN); Prahalad Deshpande, Pune (IN); Ambarish Prashant Pande, Pune (IN); Devraj Narendra Baheti, Pune (IN)

(21) Appl. No.: 17/474,082

(22) Filed: Sep. 14, 2021

(30) Foreign Application Priority Data
Jul. 23, 2021 (IN) 202141033228

(51) Int. Cl. H04L 29/06; G06F 9/455

(52) U.S. Cl. CPC H04L 63/20; H04L 63/0263; H04L 63/0236; G06F 9/45558; G06F 2009/45595; G06F 2009/4557

(57) ABSTRACT

This document describes a network policy evaluation platform that evaluates, validates, and troubleshoots network policy configurations. In one aspect, a method includes obtaining a first network policy applied by a container orchestration platform for managing network traffic for a cluster of container workloads. First network rules are extracted from the first network policy. A canonical rule model is generated for the first network rule(s). A second network policy applied by a network provider plugin configured to run within the cluster and to manage the network traffic for the cluster of container workloads is obtained. Second network rules are extracted from the second network policy. A canonical rule model is generated for the one or more second network rules. One or more conflicts between the first network policy and the second network policy are detected based on an evaluation of each first canonical rule model and each second canonical rule model.

### RELATED APPLICATION

Benefit is claimed under 35 U.S.C. 119(a)-(d) to Foreign Application Serial No. 202141033228 filed in India entitled “FRAMEWORK FOR VALIDATING AND TROUBLESHOOTING NETWORK POLICY CONFIGURATIONS”, on Jul. 23, 2021, by VMware, Inc., which is herein incorporated in its entirety by reference for all purposes.

### TECHNICAL FIELD

This specification is related to data communication networks.

### BACKGROUND

Container orchestration platforms provide support for deployment, management, scaling, and networking of containers. The network functionality for the containers running on these orchestration platforms are typically provided by Container Networking Interface (CNI) plugins. There are multiple different CNI plugins that each have their own network security mechanisms for container workloads, which can use a combination of core network policies of the container orchestration framework along with plugin-specific policies. For example, in a Kubernetes® system, a CNI can use a combination of core Kubernetes® network policies along with plugin-specific Custom Resource Definitions (CRDs).

Network policy prioritization strategies are plugin-specific which leads to complexities in determining the outcome of network policy (e.g., firewall rule) application. For example, some CRDs of a CNI plugin may take priority over core Kubernetes® network policies. Moreover, the CRDs can be ordered based on tiers and priority specified by the policy. This adds complexity to firewall rule management in container workload clusters because different user personas (e.g., cluster administrator, application owners, etc.) could potentially create conflicting network policies.

### SUMMARY

In general, this document describes systems and techniques for validating and troubleshooting network policies, such as network policies used to manage network traffic in container orchestration platforms. The network policies can include rules for network traffic, including firewall rules that control the network traffic that can pass into and/or out of a network or between particular locations on the network. As network policies can be defined for the container orchestration platform itself and for a CNI plugin that provides networking functionality for containers running on the container orchestration platform, there can be conflicts between the policies that adds complexities to network policy rule management in container workload clusters.

With CNI plugins having priorities and hierarchies between the various network policies and their associated firewall rules, while the container orchestration platform and/or other CNI plugins may not, additional complexities are introduced in determining the results of a new network policy. A network policy can include one or more rules for managing network traffic. For example, a firewall rule of the container orchestration platform may block network traffic between two Internet Protocol (IP) addresses while a new CNI plugin rule may allow network traffic between the two IP addresses in certain situations to provide a service to a container. In this example, there may be a loss of service to the container if the firewall rule of the container orchestration platform takes priority over the new CNI plugin rule.

The network policy evaluation framework described in this document can evaluate network policies from multiple sources, e.g., from the container orchestration platform, any CNI plugin, and the underlying computing infrastructure on which the container orchestration platform runs, and determine the results of the policies. Such results can indicate whether there are any conflicts between the network policies and recommended conflict remediation actions for correcting the policies. This information can be displayed in a user interface that enables a user to modify the network policies, which makes network policy management easier, faster, and more accurate than conventional techniques of simply submitting new network policies in text files.

Another problem in container orchestration is the lack of a mechanism to perform an impact assessment of a network policy change without actually applying the network policy to the cluster. The absence of a mechanism to provide a complete state of network policies rules within the cluster implies any changes done to the existing policies or applying new policies might break other parts of the application. Moreover, if there is any deviation from the expected behavior, existing CNI plugins do not provide an adequate mechanism to troubleshoot and determine the root cause.

A CNI provider specific plugin would be restricted to its own implementations, making the process of migrating from one CNI solution to another more performant/relevant one difficult, since the firewall rules would again need to be re-validated in the context of the new CNI provider being migrated to and this can happen only if the target CNI solution also provides a firewall rule validation functionality.

Further, some of the firewall validation tools spawn test containers into the container cluster to run validation tests. This makes testing in a production container cluster extremely flaky and resource intensive, since the actual application workload containers would compete with the network policy test containers for compute, memory, network, and storage resources.

The network policy evaluation framework described in this document can be implemented as an agentless, on-demand framework designed for container workloads to plan, validate, and troubleshoot CNI network policies. The network policy evaluation framework helps in visualizing the impact of applying a set of network policies at any level (e.g., cluster, namespace, or application) before even applying the rules. Unlike other solutions, the network policy evaluation framework does not require an agent to be injected in the cluster and to utilize the Kubernetes® Application Programming Interfaces (APIs) to fetch all the network policy data and proactively perform the impact analysis. The plug-in-based architecture of the network policy evaluation framework makes it easier to extend the functionality across various CNI providers. The network policy evaluation framework introduces a network provider agnostic framework which encapsulates the core tenets of firewall functionality, thereby allowing a simplified and unified experience when debugging, analyzing, or performing diagnosis of network policy rule configuration anomalies across different CNI providers.

The network policy evaluation framework can gather all the network policies at various hierarchies supported by a network provider, process the policies based on their prioritization strategies, and generate an outcome table that shows the firewall action between sets of containers, e.g., sets of pods. The network policy evaluation framework can provide functionalities like anomaly detection and pro-active alerting when there are conflicting network policies in the system. The solution can be used to provide end to end in-depth visibility by co-relating the network policies of the container orchestration platform with firewall rule data from physical (e.g., of the underlying hardware system) and virtual firewalls (e.g., of the CNI plugins) in the cluster. Additionally, the network policy evaluation framework can be integrated with other solutions, e.g., Sonobuoy, for Network Policy Conformance Testing to troubleshoot and diagnose network policy rule failures.

The subject matter described in this specification can be implemented in particular embodiments so as to realize one or more of the following advantages. The network policy evaluation framework described in this document can evaluate network policies from multiple sources, evaluate the policies, determine conflicts between the policies, and prevent conflicting policies from being applied to an application (e.g., to a cluster of containers), thereby reducing errors and loss of service that would otherwise occur due to the conflicting policies. The network policy evaluation framework can perform this evaluation and implement corrective action without introducing additional containers or other workloads into the cluster, which prevents the addition of resource intense agents/containers to clusters. This reduces the utilization of compute, memory, network, and storage resources for the cluster, freeing up resources for the containers that are running in the cluster and/or enabling additional containers to run in place of any test containers that would have otherwise been added to perform functions of the network policy evaluation framework. The network policy evaluation framework is network provider agnostic and can evaluate network policies from various network providers (e.g., CNI plugins) along with the network policies of the container orchestration platform and/or the network policies of the underlying infrastructure, which can include a virtual computing infrastructure and/or a physical computing infrastructure. For example, the network policy evaluation framework can convert firewall rules into a canonical format and evaluate the various rules.

Various features and advantages of the foregoing subject matter are described below with respect to the figures. Additional features and advantages are apparent from the subject matter described herein and the claims.

### BRIEF DESCRIPTION OF THE DRAWINGS

FIG. 1 is a block diagram of an example environment in which a network policy evaluation framework evaluates, validates, and troubleshoots network policies.

FIG. 2 is a diagram of an example process for extracting rules from network policies and generating canonical rule models.

FIG. 3 shows an example class diagram.

FIG. 4 shows example canonical rule models generated from a network policy.

FIG. 5 is a diagram of an example process for resolving groups into member workloads.

FIG. 6 is a diagram of an example process for generating and displaying an outcome table.

FIG. 7 is a diagram of an example process for integrating a network policy evaluation framework with a deployment automation framework.

FIG. 8 is a diagram of an example process for detecting conflicts between network policies.

FIG. 9 is a block diagram of an example computer system.

Like reference numbers and designations in the various drawings indicate like elements.

### DETAILED DESCRIPTION

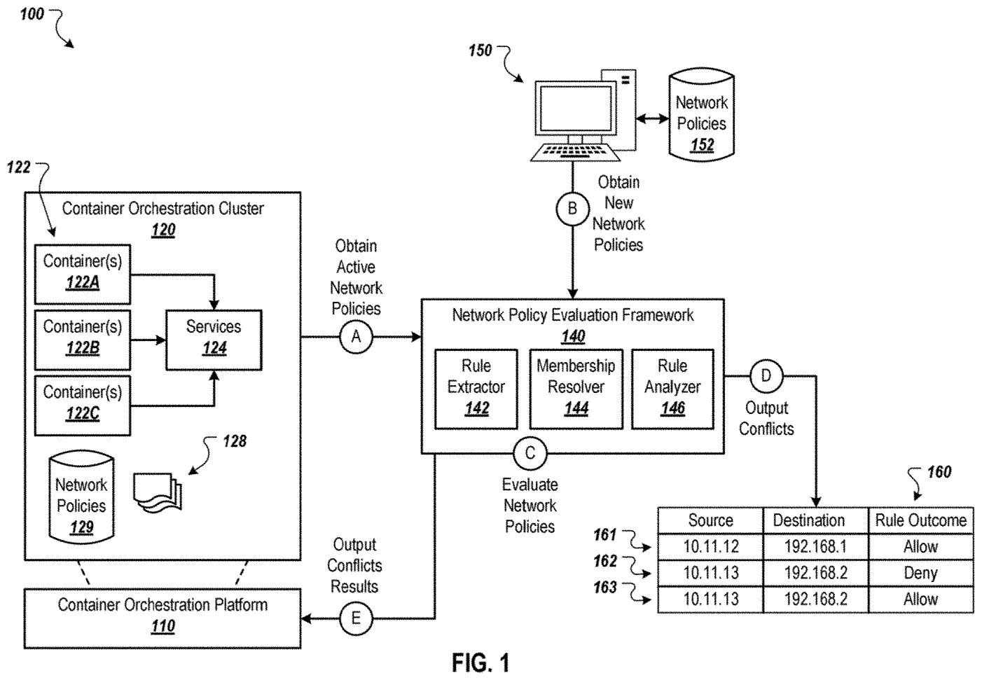

FIG. 1 is a block diagram of an example environment 100 in which a network policy evaluation framework 140 evaluates, validates, and troubleshoots network policies. In this example, the network policy evaluation framework 140 evaluates network policies for container orchestration clusters 120 hosted by a container orchestration platform 110. A container orchestration platform 110 can automate the deployment and management of containerized applications. Containerized applications can also be referred to as containers. An example container orchestration platform is Kubernetes®. The network policy evaluation framework 140 can perform similar evaluations and troubleshooting on other types of applications hosted in other types of environments, e.g., by other types of cloud computing platforms, that have multiple network policies that may conflict. The container orchestration platform 110 can include virtual and physical computing infrastructure to host container orchestration clusters 120.

A container orchestration cluster 120, which is also referred to as a cluster for brevity, can include, among other things, multiple containers 122 and services 124 for the containers 122. For example, the services 124 can include services to which the containers 122 subscribe. The containers can be arranged in pods, which each include one or more containers and shared storage and network resources.

The cluster 120 also includes network policies 128, which can be stored in a network policy data storage device 129, that manage the network traffic for the cluster 120 and its containers 122. A network policy 128 can include one or more rules, e.g., firewall rules, for managing the network traffic for the cluster 120. These rules can define network traffic that is to be allowed or blocked. For example, a rule can define that traffic from a particular IP address is blocked from entering the cluster or reaching a particular container. Another rule can define that traffic between a particular source port and a particular destination port is allowed to pass for a particular pod or a particular namespace. A namespace is a virtual cluster that is backed by a same physical cluster. For example, the cluster 120 can include multiple namespaces that each include one or more pods of container(s).

The network policies 128 represent network policies that are active for the cluster 120. That is, the network policies 128 include network policies that are currently being used by the cluster 120 to manage traffic into the cluster 120, out of the cluster 120, and/or within the cluster 120. These network policies 128 can include policies from multiple sources.

One source of network policies is the container orchestration platform 110. For example, the container orchestration platform 110 can have network policies that manage the network traffic for clusters hosted by the container orchestration platform 110. These network policies can be configured for each cluster, e.g., by a user, and/or include default policies for all clusters hosted by the container orchestration platform 110.

Another source of network policies is a network provider that is configured to run within the cluster 120. A user that is deploying containers in a cluster can select a network provider to provide network functionality for containers running in the cluster 120. Such network functionality can be provided by Container Networking Interface (CNI) plugins. Some example network providers for Kubernetes® clusters include Calico, Antrea, and Flannel. Each CNI plugin can have its own network security mechanisms for container workloads using, for example, Custom Resource Definitions (CRDs). This network provider can have network policies that manage the network traffic for the cluster 120.

Another source of network policies is network security software running on the physical computing infrastructure on which the container orchestration platform 110 is running. For example, servers that host the container orchestration platform 110 can include a firewall that manages network communications for the servers and the network to which the servers are connected. Another source of network policies is network security software of a virtual computing infrastructure on which the container orchestration platform 110 is running. For example, virtual servers, e.g., of a virtual machine, that host the container orchestration platform 110 can include a firewall that manages network communications for the virtual servers and the network to which the servers are connected.

The various sources of network policies can structure their policies in different formats and can include, or not include, different hierarchies and/or priorities for rules within the policy. For example, one source can enable a user to specify priorities between the network rules within a network policy. Another source may not have any priorities. Yet another source may have a hierarchy of rules, such that rules at higher levels within the hierarchy have priority over rules at lower levels. The different formats of network policies and the different ways in which priorities are defined makes it difficult to determine the results of the various entities applying their rules when processing network traffic.

The network policy evaluation framework 140, which can be implemented in software and/or hardware, can evaluate the network policies to detect any conflicts between rules within the policies and perform a conflict remediation action based on the evaluation. A conflict between rules can exist when different rules indicate that a different action is to be taken for the same network traffic. For example, a first rule can specify that traffic between two ports is always allowed, while a second rule indicates that traffic between the two ports is always blocked. In this example, one rule would mask the other rule, e.g., depending on which rule has a higher priority. If no conflicts are detected, the network policy evaluation framework 140 can consider the network policies validated and output, to a user or application that manages the deployment of network policies and/or clusters of containers, data specifying that the network policies have been validated.

A conflict remediation action is an action that changes or initiates a change to at least one network policy to resolve a conflict between two or more network policies. One example conflict remediation action is transmitting data describing a detected conflict to an application or platform that deploys and/or updates network policies. For example, the network policy evaluation framework 140 can transmit data identifying conflicts to the container orchestration platform 110 or to a deployment automation framework (not shown) that deploys clusters on the container orchestration platform 140.

Another example conflict remediation action is initiating the display of a user interface that shows data describing the conflict and optionally that enables a user to adjust the conflicting network policies. For example, the network policy evaluation framework 140 can cause a user interface to display data identifying the conflicts, e.g., in the form of a table 160. In this way, a user can view the conflicts and make changes to one or more of the policies to resolve the conflict. In another example, the network policy evaluation framework 140 can generate and transmit an alert that describes the conflicting network policies to a device of a user.

The network policy evaluation framework 140 can evaluate the active network policies to detect conflicts between the network policies of the container orchestration system 110, the network policies of the network provider that provides the network functionality for the clusters 120, and/or the network policies of the underlying computing infrastructure (e.g., virtual and/or physical) on which the container orchestration platform 110 runs. Such conflicts can result in errors or loss of service for a container 122. For example, if a network policy of the container orchestration platform 110 blocks traffic to a particular IP address that a container 122 needs to send data, the container 122 may be blocked from getting the data to the device at the particular IP address, resulting in a loss of service. This evaluation can be used to troubleshoot errors that may be caused by blocked data, e.g., due to conflicting network policies.

The network policy evaluation framework 140 can also evaluate new network policies for conflicts with the active network policies, e.g., to perform a “what if?” analysis. In this example, the network policy evaluation framework 140 can detect new policies that conflict with active policies and optionally prevent application of the new network policies if there is a conflict. For example, a user can use a computer 150 to generate a new network policy for containers 122 running in the cluster 120. The network policy evaluation framework 140 can receive the new network policies and evaluate the new network policies in combination with the active network policies to determine whether there are any conflicts.

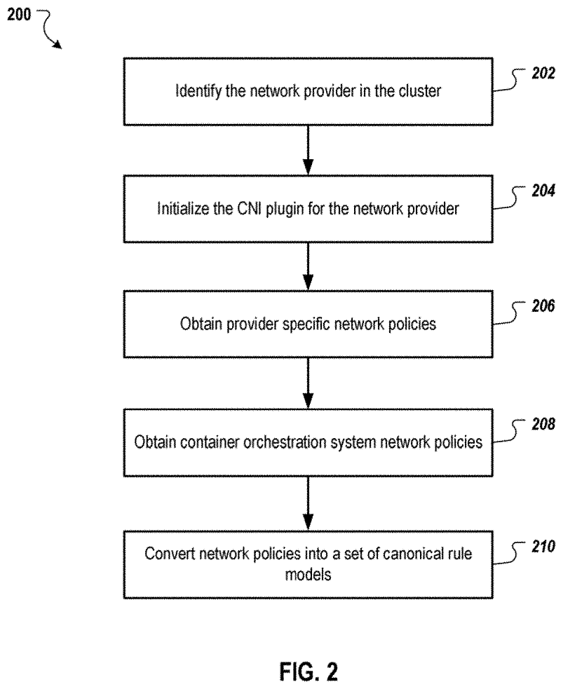

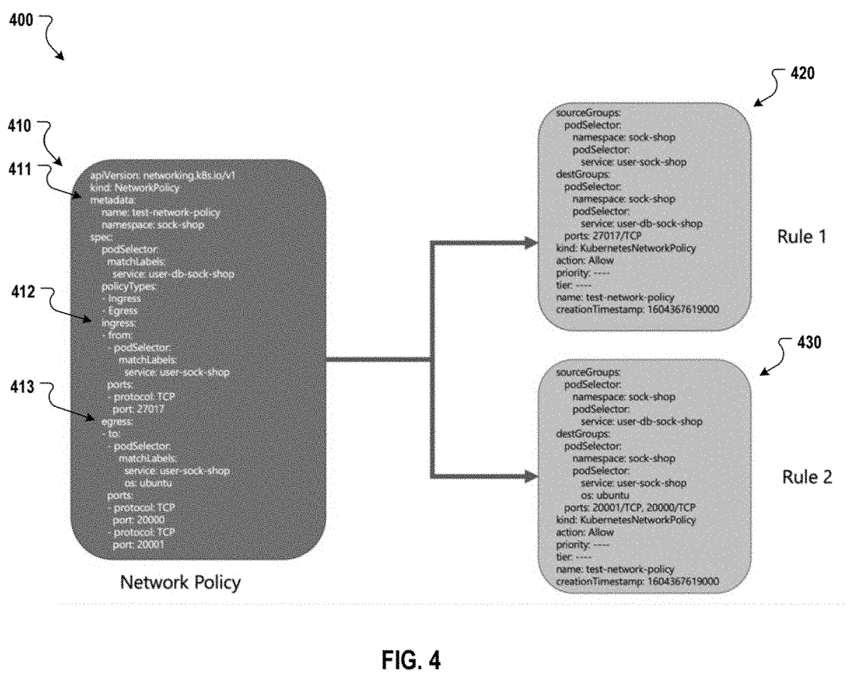

The network policy evaluation framework 140 includes a rule extractor 142, a membership resolver 144, and a rule analyzer 146. The rule extractor 142 obtains the active network policies and any new network policies (e.g., if a what if analysis is being performed) and extracts network rules from network policies and generates canonical rule models based on the extracted rules. A canonical rule model is a data structure that defines, for a network rule, an action that is performed on network traffic that is being transmitted from a particular source to a particular destination. In this context, canonical means that the canonical rule models generated from network policies for different network traffic managers (e.g., container orchestration platforms, network policy specific CNI plugins, and firewalls of virtual and/or physical computing infrastructure) have a common, structured format that enables the network policy evaluation framework 140 to analyze the rules from the various network traffic managers. As the policies differ for different network traffic managers, the rule extractor 142 can process the policies to extract the rules and put them in the canonical rule models for evaluation by the rule analyzer 146. An example process for obtaining network policies and generating canonical rule models is illustrated in FIG. 2 and described below. In addition, an example canonical rule model is shown in FIG. 4 and described below.

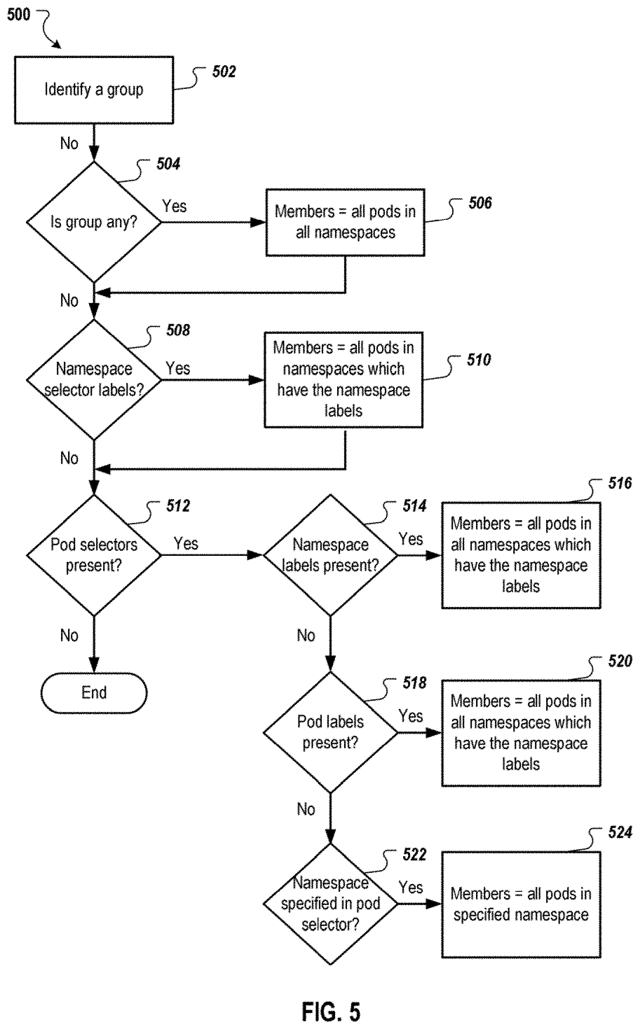

The membership resolver 144 resolves the source and destination groups into respective member workloads. This enables the rule analyzer 146 to identify the pods, containers, or workloads for which network traffic is controlled by network rules that correspond to the source and destination. This also enables the rule analyzer 146 to identify each canonical rule model that includes an action that is performed on network traffic between a particular source and a particular destination. An example process for resolving groups into member workloads is illustrated in FIG. 5 and described below.

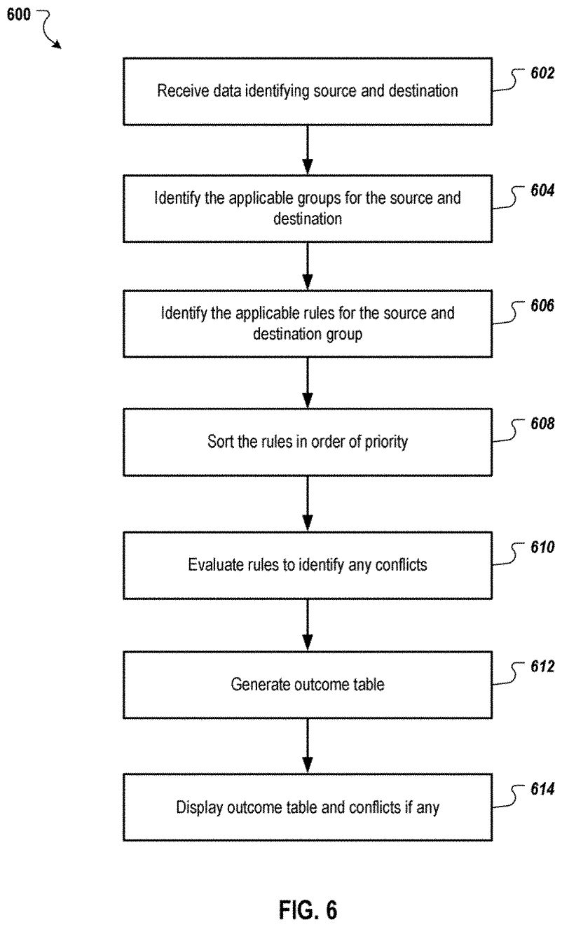

The rule analyzer 146 analyzes the canonical rule models generated by the rule extractor 142 to detect conflicts between the network rules represented by the canonical network models. This can include sorting the canonical rule models based on priority and determining whether two or more canonical rule models define different actions for the same network traffic, e.g., network traffic between two ports or two pods within the cluster 120. An example process for analyzing canonical rule models is illustrated in FIG. 6 and described below.

An example process performed by the network policy evaluation framework 140 is shown in stages A-E of FIG. 1. In stage A, the network policy evaluation framework 140 obtains the active network policies for the cluster 120. The network policy evaluation framework 140 can obtain active network policies of the container orchestration platform 110 from an API of the container orchestration platform. Similarly, the network policy evaluation framework 140 can obtain the active network policies of the network provider plugin of the network provider that provides the network functionality within the cluster 120 from an API of the container orchestration platform. The network policy evaluation framework 140 can obtain the network policies for the physical and/or virtual computing infrastructure from the API of the software implementing the network policy, e.g., and API of the provider of the infrastructure or software.

In stage B, the network policy evaluation framework 140 can obtain any new network policies, e.g., from a client device of a user that is providing new network policies for evaluation by the network policy evaluation framework 140. Stage B is included in what if analyses, but can be excluded when evaluating active network policies and/or troubleshooting network conditions for the cluster 120.

In stage C, the network policy evaluation framework 140 evaluates the canonical rule models to detect any conflicts in the network rules represented by the canonical network policies. This can include extracting the network rules from the network policies, generating the canonical rule models using the extracted network rules, sorting the canonical rule models based on priority, and determining whether two or more rules of the canonical rule models define different actions for the same network traffic.

In stage D, the network policy evaluation framework 140 outputs data indicating the results of the evaluation. This data can indicate any detected conflicts between rules represented by the canonical rule models. In one example, the data can include a table 160 that shows source and destination groups for each network rule and, for each network rule, the outcome of the network rule on the network traffic from the source to the destination. If two network rules have different outcomes on the same source and destination pair, then the network two rules conflict. In this example, network rule 161 does not have a conflict, but network rules 162 and 163 conflict as they apply to the same source and destination IP address pair and have different outcomes, i.e., network rule 162 blocks the traffic while network rule 163 allows the traffic. The network policy evaluation framework 140 can update a user interface of a client device to display the output data, e.g., the table 160.

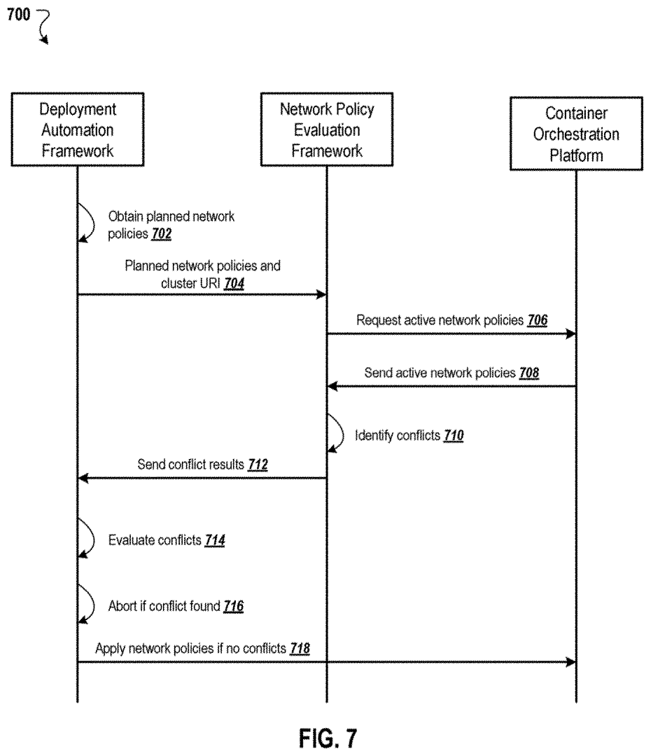

In stage E, the network policy evaluation framework 140 can also output data identifying conflicts to the container orchestration platform 110 or to a deployment automation framework (not shown) that deploys clusters on the container orchestration platform 140. In this way, the container orchestration platform 110 or the deployment automation framework can abort the deployment of conflicting network policies, as described below with reference to FIG. 7. This is an example of a conflict remediation action that prevents the application of conflicting network policies that may cause errors or service loss in response to identifying the conflicts.

In some implementations, the network policy evaluation framework 140 can recommend actions to a user and receive, from the user, a selection to approve or deny the recommendation. For example, if a network policy of the network provider allows traffic between two pods but a network policy of the container orchestration platform 110 blocks the traffic, e.g., as a default setting, the network policy evaluation framework 140 can recommend removing the network policy of the container orchestration platform 110. The network policy evaluation framework 140 can also provide a user interface control that enables the user to confirm the recommended action or deny the recommended action. If the user confirms the recommendation action, the network policy evaluation framework 140 can apply the recommended action to the appropriate network policies. This is another example of a conflict remediation action performed by the network policy evaluation framework 140.

FIG. 2 is a diagram of an example process 200 for extracting rules from network policies and generating canonical rule models. The process 200 can be performed by a network policy evaluation framework e.g., the network policy evaluation framework 140 of FIG. 1. Operations of the process 200 can also be implemented as instructions stored on one or more computer readable media which may be non-transitory, and execution of the instructions by one or more data processing apparatus can cause the one or more data processing apparatus to perform the operations of the process 200. For brevity, the process 200 is described as being performed by the network policy evaluation framework 140 of FIG. 1.

The network policy evaluation framework 140 identifies a network provider in a cluster (202). In some implementations, the network policy evaluation framework 140 maintains a list of all CNIs registered with the network policy evaluation framework 140. Each CNI can have its own CRDs created for providing network policies. These CNI introduced CRDs can be consumed using the API of the container orchestration platform, e.g., the API of a Kubernetes® platform. To identify the network provider for a cluster, the network policy evaluation framework 140 can probe each of these APIs and verify if the network provider is present in the cluster. If one is verified, e.g., by responding to the probe, the network policy evaluation framework 140 can identify that network provider as the network provider for the cluster.

The network policy evaluation framework 140 initializes the respective CNI plugin for the identified network provider (204). The network policy evaluation framework 140 then obtains the network policies for the network provider via the CNI plugin for the network provider (206). For example, the network policy evaluation framework 140 can submit an API request to the CNI plugin for the network policies and, in response, the CNI plugin can send the network policies to the network policy evaluation framework 140.

The network policy evaluation framework 140 obtains the network policies of the container orchestration platform (208). The network policy evaluation framework 140 can obtain these network policies by submitting an API request to the container orchestration platform and, in response, the container orchestration platform can send the network policies to the network policy evaluation framework 140. The network policy evaluation framework 140 can also obtain network policies of the underlying computing infrastructure, e.g., from a firewall of the infrastructure.

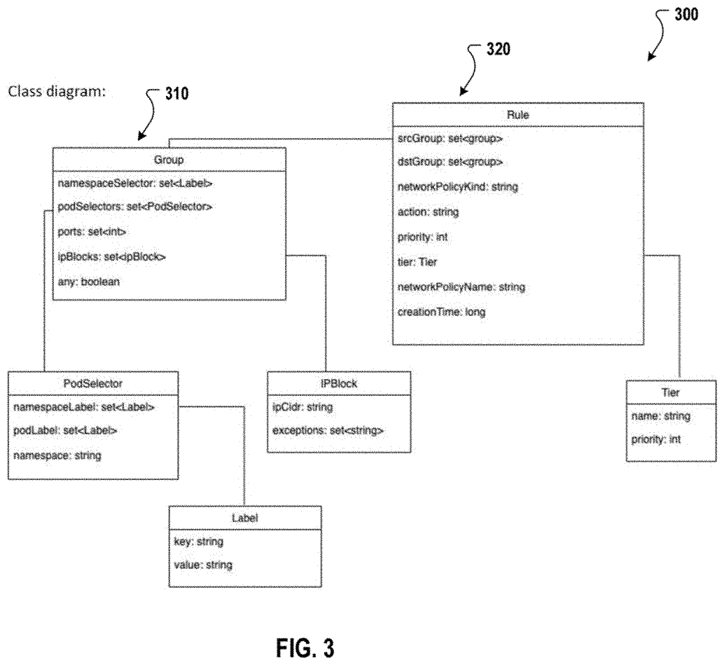

The network policy evaluation framework 140 converts the obtained network policies into a set of canonical rule models (210). This set of canonical rule models represents the network rules that are applied by the various components of the system on network traffic of the cluster. The set of canonical rule models can include a canonical rule model for each rule of the network policies. The conversion of the network policies is described with reference to FIGS. 3 and 4. FIG. 3 shows an example class diagram 300 and FIG. 4 shows example canonical rule models 420 and 430 generated from a network policy 410.

In general, each network policy will have some common components, such as components that identify the type of traffic (e.g., ingress or egress), the action to take (e.g., allow or block), and data indicating the source and destination of the traffic for which the action is to be taken. However, this information can be in different formats and include different information (e.g., priority information) depending on the source of the network policies.

The rule extractor 142 of the network policy evaluation framework 140 can be configured to identify the appropriate components of each source of network policies and extract that data from those components of the network policies. The rule extractor 142 can then generate a canonical rule model for each rule found in a network policy using the extracted data.

In some implementations, the rule extractor 142 generates group data structures (which are also referred to as groups for brevity) from a network policy and generates the canonical rule model for a rule of the network policy using a generated group. The rule extractor 142 can generate a group for a source and a group for a destination for each rule. The source group defines the source of network traffic to which a rule applies. Similarly, the destination group defines the destination of network traffic to which a rule applies. The group data structure can include various parameters that define a source or destination of network traffic. For each network policy, the rule extractor 142 can identify the source and destination and generate a group for the source and a group for the destination using the information in the network policy that defines the source and destination.

Referring to FIG. 3, a class 300 can include a group data structure 310 that includes, as labels for various parameters, a namespace selector, a pod selector, network ports, ipBlocks, and a Boolean value for an “any” field. If the “any” field has a value of true or one, the rule corresponding to the group applies to all of the pods in all of the namespaces of the cluster. The rule extractor 142 can be configured to identify the values for these fields within each type of network policy and generate the group 310 using the extracted values. If a network policy includes multiple rules, the rule extractor 142 can identify the multiple rules and generate a respective group 310 for the source for each rule and a respective group 310 for the destination of each rule.

The labels within the group 310 define the network traffic to which rule(s) corresponding to the group applies. The namespace selector defines the namespaces to which the rule(s) apply; the pod selector indicates the pods of each namespace to which the rule applies; the ports label indicates the network ports to which the rule(s) apply; and the ipBlocks label specifies IP Classless Inter-Domain Routing (CIDR) ranges for source and destinations and exception IP addresses, if any.

The groups 310 are used in the rule evaluation process to identify the rules that apply to source and destination pairs being evaluated. Each group 310 can be linked within the class to one or more canonical rule models 320 that include the source or destination represented by the group. In this example, the canonical rule model 320 includes, as labels, a source group, a destination group, a network policy kind (or type), an action (e.g., deny or allow traffic), a priority, a tier, network policy name for the network policy from which the rule was extracted, and a creation time for the canonical rule model 320. The source group and destination group labels can be in the form of selectors that define the source group or destination group, e.g., using a namespace selector, a pod selector, and/or ports. If the rule applies to any groups, the source and destination label can be “any.” In another example, each group 310 can have a unique identifier and these labels can include the group identifiers for the source and destination to which the rule applies.

Referring to FIG. 4, two canonical rule models 420 and 430 have been generated from a network policy 410 that includes two rules, i.e., an ingress rule 412 and an egress rule 413. The network policy 410 also includes metadata 411 that includes the name of the network policy and the namespace to which the network rules of the network policy apply. The canonical rule model 420 is generated for the ingress rule 412 and the canonical rule model 430 is generated for the egress rule 413. As shown in FIG. 4, the canonical rule model 420 includes the namespace (sock-shop) of the network policy 410, the pod selector (service: user-db-sock-shop), and the port (27017) from the ingress rule 412. Similarly, the canonical rule model 430 includes the namespace (sock-shop) of the network policy 410, the pod selector (service: user-sock-shop), and the ports (20000 and 200001) from the egress rule 413. The rule extractor 142 can generate the canonical rule models 420 and 430 by extracting the appropriate data from the network policy 410.

FIG. 5 is a diagram of an example process 500 for resolving groups into member workloads. This can be performed to map selectors of groups to the pods to which the groups correspond. The mappings can include data specifying that the pods belong to the group, e.g., by linking the pods to the group or by including a list of the pods in a data file for the group. With such mapping, the network policy evaluation framework 140 can identify the groups and canonical rule models corresponding to a source and destination and identify the pods/containers that may be affected by the network rules corresponding to the source and destination. In this way, the network policy evaluation framework 140 can evaluate each network rule for a source and destination pair to determine whether there are any conflicts with the network rules. The mapping also provides a mechanism to find rules that are applicable to input pods. This mechanism provides an easier and faster way to lookup rules based on the inputs, e.g., based on source and destination inputs as described below with reference to FIG. 6.

The process 500 can be performed by a network policy evaluation framework e.g., the network policy evaluation framework 140 of FIG. 1. Operations of the process 500 can also be implemented as instructions stored on one or more computer readable media which may be non-transitory, and execution of the instructions by one or more data processing apparatus can cause the one or more data processing apparatus to perform the operations of the process 500. For brevity, the process 500 is described as being performed by the network policy evaluation framework 140 of FIG. 1.

The network policy evaluation framework 140 identifies a group (502). In some implementations, the network policy evaluation framework 140 can resolve the groups in sequence, e.g., one group at a time. The groups include the groups generated based on the network policies for a cluster.

The network policy evaluation framework 140 determines whether the group applies to any containers/pods in the cluster (504). For example, the network policy evaluation framework 140 can determine whether an “any” label is set to true or one in the group.

If the group applies to any containers/pods in the cluster, the network policy evaluation framework 140 can resolve the group to all pods in all namespaces in the cluster (506). That is, the network policy evaluation framework 140 can map the group to all of the pods in the cluster.

The network policy evaluation framework 140 determines whether the group includes any namespace selector labels (508). If so, the network policy evaluation framework 140 maps the group to all pods in the namespaces for which the group includes a namespace label (510). For example, if the group includes the namespace label “example namespace,” then the network policy evaluation framework 140 maps the group to the pods in the example namespace.

The network policy evaluation framework 140 determines whether the group includes any pod selectors (512). If not, the process for resolving this group to members ends, but can be repeated for other groups.

If so, the network policy evaluation framework 140 determines whether there are any namespace labels present in the group (514). If so, the network policy evaluation framework 140 maps the group to all pods in all namespaces that have the namespace labels (516). In this case, there are no pod selectors, whereas the members identified in operation 510 includes pod selectors.

If not, the network policy evaluation framework 140 determines whether the group includes any pod labels (518). If so, the network policy evaluation framework 140 maps the group to all pods in all namespaces that have the pod label (520).

If not, the network policy evaluation framework 140 determines whether there is a namespace group specified in the pod selector (522). If so, the network policy evaluation framework 140 maps the group to all pods in the specified namespace. The network policy evaluation framework 140 can repeat the process 500 to map each group to its corresponding pods.

FIG. 6 is a diagram of an example process 600 for generating and displaying an outcome table. The process 600 can be performed by a network policy evaluation framework e.g., the network policy evaluation framework 140 of FIG. 1. Operations of the process 600 can also be implemented as instructions stored on one or more computer readable media which may be non-transitory, and execution of the instructions by one or more data processing apparatus can cause the one or more data processing apparatus to perform the operations of the process 600. For brevity, the process 600 is described as being performed by the network policy evaluation framework 140 of FIG. 1.

The network policy evaluation framework 140 receives data identifying a source and destination (602). The source and destination can be specified as IP addresses, container services, pods, or individual containers. In this way, the network policy evaluation framework 140 can determine, using the canonical rule models, whether network rules of network policies that manage network traffic between the source and destination conflict.

The network policy evaluation framework 140 identifies applicable groups for the source and destination (604). The network policy evaluation framework 140 can use the mapping between the groups and the pods to identify the groups. For example, the network policy evaluation framework 140 can identify each group that is mapped to any of the source pod(s) and each group that is mapped to any of the destination pod(s).

The network policy evaluation framework 140 identifies the applicable canonical rule models for the source group(s) and the destination group(s) (606). In some implementations, the network policy evaluation framework 140 identifies each canonical rule model that has a source group and destination group in the set of groups identified in operation 604. These canonical rule models represent the network rules that apply to traffic between at least one source pod and at least one destination pod of the source and destination received in operation 602.

The network policy evaluation framework 140 sorts the canonical rule models in order based on priority (608). In some implementations, the network policy evaluation framework 140 sorts the canonical rule models independently based on the source of the network policy from which the canonical rule models were generated. For some network providers, the network policy evaluation framework 140 can first order the canonical rule models based on tier and then based on priority within the tiers, e.g., from Antrea implementations.

The network policy evaluation framework 140 evaluates the canonical rule models to determine whether there are any conflicts between the rules represented by the canonical rule models (610). This can include identifying each canonical rule model that includes the same source group and the same destination group. That is, this can include identifying each canonical rule model that represents a network rule that manages network traffic between a particular source and a particular destination. Once identified, the network policy evaluation framework 140 can determine whether the actions included in the identified canonical rule models are different for the identified canonical rule models. If so, there is a conflict.

The network policy evaluation framework 140 generates an outcome table for the source and destination (612). An example outcome table 160 is shown in FIG. 1. This table 160 includes a row for each canonical rule model and each row includes the source and destination of network traffic managed by the network rule represented by the canonical rule model and the outcome action for the network rule (e.g., allow or deny network traffic between the source and destination).

This table 160 can be used to identify conflicts. For example, if two canonical rule models have the same source and destination, but different outcomes, there is a conflict. Any conflicting rules can be highlighted in the table, e.g., using different color text, different backgrounds, etc.

The outcome table is displayed (614). For example, the network policy evaluation framework 140 can update a user interface of a client device to display the outcome table to a user.

FIG. 7 is a diagram of an example process 700 for integrating a network policy evaluation framework with a deployment automation framework. The process 700 can be performed in collaboration by the deployment automation framework, the network policy evaluation framework 140, and a container orchestration platform.

The network policy evaluation framework 140 can integrate with deployment automation frameworks, e.g., vRealize Automation, Ansible, Terraform, etc., to check network policy configuration anomalies and prevent the deployment of faulty configurations at the source. This helps in reducing downtime and unexpected loss of application functionality due to incorrect firewall rule configurations in cloud native environments.

The deployment automation framework obtains planned network policies (702). For example, a user can specify the planned network policies and provide the planned network policies to the deployment automation framework.

The deployment automation framework sends the planned network policies and a resource location (e.g., URI) for the cluster to the network policy evaluation framework (704).

The network policy evaluation framework 140 requests, from the container orchestration platform 110, the active network policies of the container orchestration platform (706). These network policies can include the network policies of the container orchestration platform 110, the network policies of the network provider that manages network functionality in the cluster, and the network policies of the underlying computing infrastructure (e.g., virtual and/or physical) that hosts the container orchestration platform 110.

The network policy evaluation framework 140 identifies any conflicts between the network rules of the active network policies and the planned network policies (710). For example, the network policy evaluation framework 140 can perform the processes 200, 500, and 600 or the process 800 to identify any conflicts.

The network policy evaluation framework 140 sends the conflict results to the deployment automation framework (712). This conflict results data can identify any detected conflicts, e.g., by identifying the canonical rule models (or their corresponding network rules or network policies) that conflict with each other. In another example, the conflict results data can be in the form of an outcome table.

The deployment automation framework evaluates the conflict results (714). For example, the deployment automation framework can evaluate the conflict results to determine whether there is a conflict between a planned network policy and an active network policy. In another example, the deployment automation framework can evaluate the conflict results to determine whether there is a conflict between any of the network policies (e.g., two or more planned policies, two or more active policies, or any combination of policies).

If there is a conflict, the deployment automation framework can abort the deployment of the planned network policies to the cluster (716). If there are no conflicts, the deployment automation framework can deploy the planned network policies to the cluster (718).

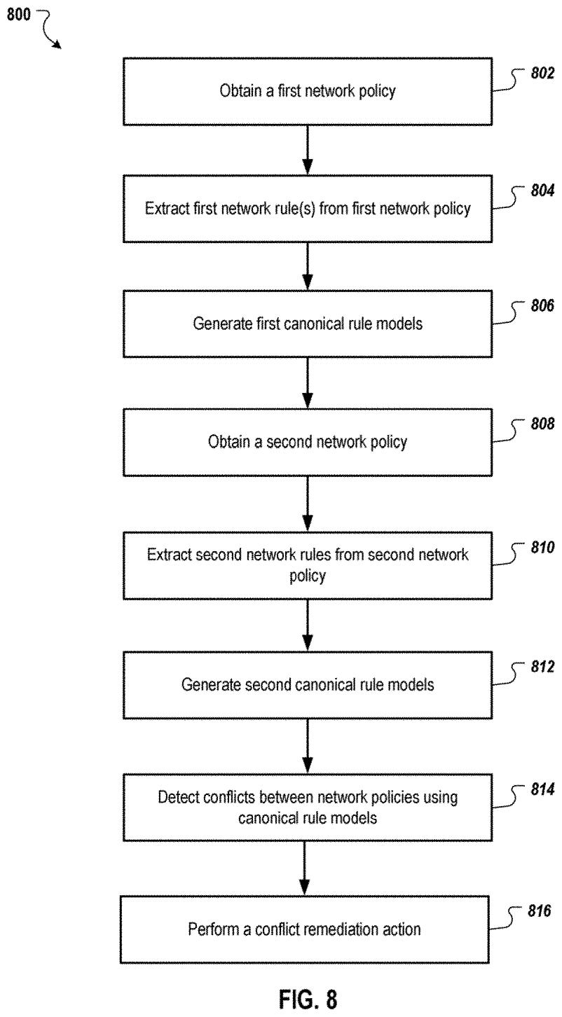

FIG. 8 is a diagram of an example process 800 for detecting conflicts between network policies. The process 800 can be performed by a network policy evaluation framework e.g., the network policy evaluation framework 140 of FIG. 1. Operations of the process 800 can also be implemented as instructions stored on one or more computer readable media which may be non-transitory, and execution of the instructions by one or more data processing apparatus can cause the one or more data processing apparatus to perform the operations of the process 800. For brevity, the process 800 is described as being performed by the network policy evaluation framework 140 of FIG. 1.

The network policy evaluation framework 140 obtains a first network policy applied by a container orchestration platform for managing network traffic for a cluster of container workloads (802). The first network policy can be an active network policy being used by the container orchestration platform for the cluster.

The network policy evaluation framework 140 extracts one or more first network rules from the first network policy (804). The network policy evaluation framework 140 generates a respective first canonical rule model for each of the one or more first network rules (806). For example, the network policy evaluation framework 140 can perform the process 200 of FIG. 2 to generate the first canonical rule model.

The network policy evaluation framework 140 obtains a second network policy applied by a network provider plugin configured to run within the cluster and to manage the network traffic for the cluster of container workloads (808). The second network policy can be an active network policy being used by the network provider plugin for the cluster.

The network policy evaluation framework 140 extracts one or more second network rules from the second network policy (810). The network policy evaluation framework 140 generates a respective second canonical rule model for each of the one or more second network rules (812). For example, the network policy evaluation framework 140 can perform the process 200 of FIG. 2 to generate the second canonical rule model.

The network policy evaluation framework 140 detects, based on an evaluation of each first canonical rule model and each second canonical rule model, one or more conflicts between the first network policy and the second network policy. For example, the network policy evaluation framework 140 can perform the process 600 of FIG. 6 to detect the conflicts.

The network policy evaluation framework 140 performs a conflict remediation action in response to detecting the one or more conflicts (814). The action can be, for example, displaying data describing the conflict(s), preventing deployment/application of a conflicting network policy, or recommending a corrective action to correct the conflict.

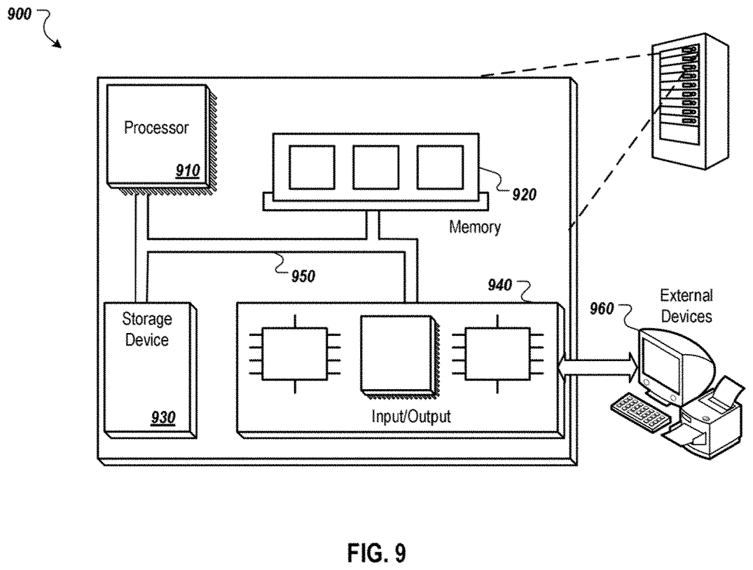

FIG. 9 is a block diagram of an example computer system 900 that can be used to perform operations described above. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In some implementations, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In some implementations, the memory 920 is a volatile memory unit. In another implementation, the memory 920 is a non-volatile memory unit.

The storage device 930 is capable of providing mass storage for the system 900. In some implementations, the storage device 930 is a computer-readable medium. In various different implementations, the storage device 930 can include, for example, a hard disk device, an optical disk device, a storage device that is shared over a network by multiple computing devices (e.g., a cloud storage device), or some other large capacity storage device.

The input/output device 940 provides input/output operations for the system 900. In some implementations, the input/output device 940 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 960, e.g., keyboard, printer and display devices. Other implementations, however, can also be used, such as mobile computing devices, mobile communication devices, set-top box television client devices, etc.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following embodiments are also innovative:

Embodiment 1 is a computer-implemented method comprising:
obtaining a first network policy applied by a container orchestration platform for managing network traffic for a cluster of container workloads;
extracting one or more first network rules from the first network policy;
generating a respective first canonical rule model for each of the one or more first network rules;
obtaining a second network policy applied by a network provider plugin configured to run within the cluster and to manage the network traffic for the cluster of container workloads;
extracting one or more second network rules from the second network policy;
generating a respective second canonical rule model for each of the one or more second network rules;
detecting, based on an evaluation of each first canonical rule model and each second canonical rule model, one or more conflicts between the first network policy and the second network policy; and
performing a conflict remediation action in response to detecting the one or more conflicts.

Embodiment 2 is the computer-implemented method of embodiment 1, wherein performing the conflict remediation action comprises causing a deployment application framework to prevent application of at least one network rule to network traffic for the cluster based on the detected one or more conflicts.

Embodiment 3 is the computer-implemented method of any one of embodiments 1 through 2, wherein performing the conflict remediation action comprises updating a user interface to display data describing the one or more conflicts.

Embodiment 4 is the computer-implemented method of embodiment 3, wherein performing the conflict remediation action comprises updating a user interface to display data describing the one or more conflicts.

Embodiment 5 is the computer-implemented method of any one of embodiments 1 through 4, wherein the first set of network rules comprises firewall rules for a firewall of the container orchestration platform and the second set of network rules comprises firewall rules for a firewall of the network provider plugin.

Embodiment 6 is the computer-implemented method of any one of embodiments 1 through 5, further comprising obtaining, by the network policy evaluation framework, a third network policy comprising a third set of network rules applied by at least one of (i) a physical firewall of physical computing infrastructure that hosts the container orchestration platform or (ii) a virtual firewall of a virtual computing infrastructure that hosts the container orchestration platform.

Embodiment 7 is the computer-implemented method of any one of embodiments 1 through 6, further comprising:
obtaining a planned network policy;
determining whether any planned rule of the planned network policy conflicts with any of the first network rules or the second network rules; and
in response to determining that any planned rule of the planned network policy conflicts with any of the first network rules or the second network rules, outputting data that causes an application to prevent deployment of the planned network policy.

Embodiment 8 is the computer-implemented method of any one of embodiments 1 through 7, further comprising:
generating, for each first network rule, a first source group for a source of network traffic to which the first network rule applies and a first destination group for a destination for network traffic to which the first rule applies; and
mapping each first source group and each first destination group to pods of containers for which the first network rule manages network traffic.

Embodiment 9 is the computer-implemented method of embodiment 8, further comprising:
generating, for each second network rule, a second source group for a source of network traffic to which the second network rule applies and a second destination group for a destination for network traffic to which the second rule applies; and
mapping each second source group and each second destination group to pods of containers for which the first network rule manages network traffic.

Embodiment 10 is the computer-implemented method of any one of embodiments 1 through 9, wherein detecting the one or more conflicts between the first network policy and the second network policy comprises a particular first network rule and a particular second network rule that have different actions for a same source group and a same destination group.

Embodiment 11 is a system comprising: one or more processors and one or more storage devices storing instructions that, when executed by the one or more processors, cause the one or more processor to perform the method of any one of embodiments 1 to 10.

Embodiment 12 is a computer readable storage medium carrying instructions that, when executed by one or more processors, cause the one or more processors to perform the method of any one of embodiments 1 to 10.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a first network policy applied by a container orchestration platform for managing network traffic for a cluster of container workloads;
extracting one or more first network rules from the first network policy;
generating a respective first canonical rule model for each of the one or more first network rules;
obtaining a second network policy applied by a network provider plugin configured to run within the cluster and to manage the network traffic for the cluster of container workloads;
extracting one or more second network rules from the second network policy;
generating a respective second canonical rule model for each of the one or more second network rules;
detecting, based on an evaluation of each first canonical rule model and each second canonical rule model, one or more conflicts between the first network policy and the second network policy; and
performing a conflict remediation action in response to detecting the one or more conflicts.

2. The computer-implemented method of claim 1, wherein performing the conflict remediation action comprises causing a deployment application framework to prevent application of at least one network rule to network traffic for the cluster based on the detected one or more conflicts.

3. The computer-implemented method of claim 1, wherein performing the conflict remediation action comprises updating a user interface to display data describing the one or more conflicts.

4. The computer-implemented method of claim 3, wherein the data describing the one or more conflicts comprises an outcome table that includes, for each canonical rule model, a source, a destination, and an outcome of the rule on network traffic between the source and the destination.

5. The computer-implemented method of claim 1, wherein the first set of network rules comprises firewall rules for a firewall of the container orchestration platform and the second set of network rules comprises firewall rules for a firewall of the network provider plugin.

6. The computer-implemented method of claim 1, further comprising obtaining, by the network policy evaluation framework, a third network policy comprising a third set of network rules applied by at least one of (i) a physical firewall of physical computing infrastructure that hosts the container orchestration platform or (ii) a virtual firewall of a virtual computing infrastructure that hosts the container orchestration platform.

7. The computer-implemented method of claim 1, further comprising:
obtaining a planned network policy;
determining whether any planned rule of the planned network policy conflicts with any of the first network rules or the second network rules; and
in response to determining that any planned rule of the planned network policy conflicts with any of the first network rules or the second network rules, outputting data that causes an application to prevent deployment of the planned network policy.

8. The computer-implemented method of claim 1, further comprising:
generating, for each first network rule, a first source group for a source of network traffic to which the first network rule applies and a first destination group for a destination for network traffic to which the first rule applies; and
mapping each first source group and each first destination group to pods of containers for which the first network rule manages network traffic.

9. The computer-implemented method of claim 8, further comprising:
generating, for each second network rule, a second source group for a source of network traffic to which the second network rule applies and a second destination group for a destination for network traffic to which the second rule applies; and
mapping each second source group and each second destination group to pods of containers for which the first network rule manages network traffic.

10. The computer-implemented method of claim 9, wherein detecting the one or more conflicts between the first network policy and the second network policy comprises a particular first network rule and a particular second network rule that have different actions for a same source group and a same destination group.

11. A system comprising:
one or more processors; and
one or more storage devices storing instructions that, when executed by the one or more processors, cause the one or more processor to perform operations comprising:
obtaining a first network policy applied by a container orchestration platform for managing network traffic for a cluster of container workloads;
extracting one or more first network rules from the first network policy;
generating a respective first canonical rule models for each of the one or more first network rules;
obtaining a second network policy applied by a network provider plugin configured to run within the cluster and to manage the network traffic for the cluster of container workloads;
extracting one or more second network rules from the second network policy;
generating a respective second canonical rule model for each of the one or more second network rules;
detecting, based on an evaluation of each first canonical rule model and each second canonical rule model, one or more conflicts between the first network policy and the second network policy; and
performing a conflict remediation action in response to detecting the one or more conflicts.

12. The system of claim 11, wherein performing the conflict remediation action comprises causing a deployment application framework to prevent application of at least one network rule to network traffic for the cluster based on the detected one or more conflicts.

13. The system of claim 11, wherein performing the conflict remediation action comprises updating a user interface to display data describing the one or more conflicts.

14. The system of claim 13, wherein the data describing the one or more conflicts comprises an outcome table that includes, for each canonical rule model, a source, a destination, and an outcome of the rule on network traffic between the source and the destination.

15. The system of claim 11, wherein the first set of network rules comprises firewall rules for a firewall of the container orchestration platform and the second set of network rules comprises firewall rules for a firewall of the network provider plugin.

16. The system of claim 11, wherein the operations comprise obtaining, by the network policy evaluation framework, a third network policy comprising a third set of network rules applied by at least one of (i) a physical firewall of physical computing infrastructure that hosts the container orchestration platform or (ii) a virtual firewall of a virtual computing infrastructure that hosts the container orchestration platform.

17. The system of claim 11, wherein the operations comprise:
obtaining a planned network policy;
determining whether any planned rule of the planned network policy conflicts with any of the first network rules or the second network rules; and
in response to determining that any planned rule of the planned network policy conflicts with any of the first network rules or the second network rules, outputting data that causes an application to prevent deployment of the planned network policy.

18. The system of claim 11, wherein the operations comprise:
generating, for each first network rule, a first source group for a source of network traffic to which the first network rule applies and a first destination group for a destination for network traffic to which the first rule applies; and
mapping each first source group and each first destination group to pods of containers for which the first network rule manages network traffic.

19. The system of claim 18, wherein the operations comprise:
generating, for each second network rule, a second source group for a source of network traffic to which the second network rule applies and a second destination group for a destination for network traffic to which the second rule applies; and
mapping each second source group and each second destination group to pods of containers for which the first network rule manages network traffic.

20. A computer readable storage medium carrying instructions that, when executed by one or more processors, cause the one or more processors to perform operations comprising:
obtaining a first network policy applied by a container orchestration platform for managing network traffic for a cluster of container workloads;
extracting one or more first network rules from the first network policy;
generating a respective first canonical rule model for each of the one or more first network rules;
obtaining a second network policy applied by a network provider plugin configured to run within the cluster and to manage the network traffic for the cluster of container workloads;
extracting one or more second network rules from the second network policy;
generating a respective second canonical rule model for each of the one or more second network rules;
detecting, based on an evaluation of each first canonical rule model and each second canonical rule model, one or more conflicts between the first network policy and the second network policy; and
performing a conflict remediation action in response to detecting the one or more conflicts.
